(19) United States
(12) Patent Application Publication
(10) Pub. No.: US 2004/0218041 A1
(43) Pub. Date: Nov. 4, 2004

(54) Outside mirror for vehicle

(75) Inventor: Hajime Yagi, Isehara-shi (JP)

Correspondence Address: FOLEY AND LARDNER, SUITE 500, 3000 K STREET NW, WASHINGTON, DC, 20007, US

(73) Assignee: Ichikoh Industries, Ltd.

(21) Appl. No.: 10/763,417

(22) Filed: Jan. 26, 2004

(30) Foreign Application Priority Data
Jan. 30, 2003 (JP) 2003-022336
Jan. 31, 2003 (JP) 2003-024887

(51) Int. Cl. H04N 7/18

(52) U.S. Cl. 348/148; 348/143

(57) ABSTRACT

An outside mirror for a vehicle includes an image capturing unit and a visible-light emitting unit that emits visible light. Relative positional relation between the image capturing unit and the visible-light emitting unit is such that the visible light does not directly enter into the image capturing unit.

### CROSS-REFERENCE TO RELATED APPLICATIONS

The present document incorporates by reference the entire contents of Japanese priority document, 2003-22336 filed in Japan on Jan. 30, 2003, and 2003-24887 filed in Japan on Jan. 31, 2003.

### BACKGROUND OF THE INVENTION

1) Field of the Invention

The present invention relates to a vehicle mirror unit that includes an image capturing unit and an infrared emitting unit.

2) Description of the Related Art

Japanese Patent Application Laid Open No. 2000-062531 discloses a technology related to an outside mirror for a vehicle, which includes an image capturing unit. U.S. patent application No. 2002/0118282 discloses a technology related to an outside mirror for a vehicle, which includes an image capturing unit and an infrared emitting unit. In both of the technologies, a video image captured by the image capturing unit allows a driver to visually recognize near a front wheel of a vehicle (axle shaft of the front wheel or around the ground where the front wheel makes a contact), and therefore, the blind spots near the front wheel can be seen clearly.

However, both of the technologies do not take how to provide a visible-light emitting unit into consideration at all. Therefore, if the visible-light emitting unit is provided without any consideration, visible light emitted from the visible-light emitting unit may directly enter into the image capturing unit. In this case, blooming or halation occurs in the video image captured by the image capturing unit, which causes visibility to be degraded. In order to solve deficiency in visibility, an additional component such as a filter is provided in the image capturing unit. However, this also causes degradation in performance such as minimum subject illumination or increase in component costs.

### SUMMARY OF THE INVENTION

It is an object of the present invention to solve at least the problems in the conventional technology.

The outside mirror for a vehicle, according to one aspect of the present invention includes an image capturing unit and a visible-light emitting unit that emits visible light. The visible-light emitting unit is arranged such that the visible light emitted does not enter into the image capturing unit.

The outside mirror for a vehicle, according to another aspect of the present invention includes an image capturing unit, and infrared emitting unit that emits infrared ray, and a visible-light emitting unit that emits visible light. The visible-light emitting unit is arranged such that the visible light emitted does not enter into the image capturing unit.

The outside mirror for a vehicle, according to still another aspect of the present invention includes an image capturing unit and a visible-light emitting unit that emits visible light. The image capturing unit captures an image of an area illuminated by the visible-light emitted or near the area. The visible-light emitting unit is arranged such that the visible light emitted does not enter into the image capturing unit.

The outside mirror for a vehicle, according to still another aspect of the present invention includes an image capturing unit and a visible-light emitting unit that emits visible light. The visible-light emitting unit illuminates an area where the image capturing unit captures an image or near the area. The visible-light emitting unit is arranged such that the visible light emitted does not enter into the image capturing unit.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is an external view of an outside mirror for a vehicle, according to a first embodiment of the present invention;

FIG. 2 is a schematic diagram for illustrating relative positional relation between an objective lens of an image capturing unit and a light source of a visible-light emitting unit, combining a partial cross section alone a IIA-IIA line with a partial cross section along a IIB-IIB line shown in FIG. 1;

FIG. 3 is a cross section along a III-III line shown in FIG. 1 for illustrating the relative positional relation between the objective lens and the light source;

FIG. 4 is an external view of an outside mirror for a vehicle, according to a second embodiment of the present invention;

FIG. 5 is a schematic diagram for illustrating relative positional relation between an objective lens of an image capturing unit and a light source of a visible-light emitting unit, combining a partial cross section along a VA-VA line with a partial cross section along a VB-VB line shown in FIG. 4;

FIG. 6 is a cross section along a VI-VI line shown in FIG. 4 for illustrating the relative positional relation between the objective lens and the light source;

FIG. 7 is a schematic diagram of a flexible substrate and LEDs for emitting infrared rays of the outside mirror according to the second embodiment, which includes an infrared emitting unit and the visible-light emitting unit;

FIG. 8 is a schematic diagram of the flexible substrate for illustrating LEDs for emitting visible light, viewed from the direction of arrow VIII shown in FIG. 7;

FIG. 9 is a schematic diagram of the flexible substrate for illustrating the LEDs for emitting visible light and the LEDs for emitting infrared rays, viewed from the direction of arrow IX shown in FIG. 8; and

FIG. 10 is a cross section of an outside mirror according to a modification of the second embodiment.

### DETAILED DESCRIPTION

Exemplary embodiments of an outside mirror for a vehicle, according to the present invention are explained in detail below with reference to the accompanying drawings.

In this specification, a left side of the vehicle (automobile) is defined as the left side when a driver looks ahead (an advance direction of the vehicle). A right side thereof is defined as the right side when the driver looks ahead. Furthermore, a front side of the body is defined as the front side when the driver looks ahead, while a rear side of the body is defined as the rear side when the driver looks ahead.

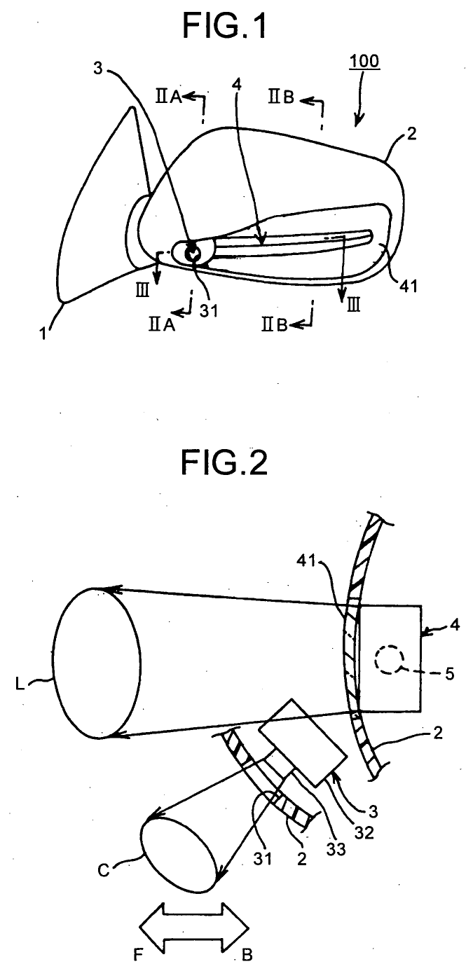

FIG. 1 to FIG. 3 are schematic diagrams of an outside mirror for a vehicle, according to a first embodiment of the present invention. An outside mirror 100 is a door mirror mounted on the left side of the vehicle and including a mirror base 1 and a mirror housing 2. The back of the mirror housing 2 is directed toward the front side F of the body.

Mounted on the lower part of the back of the mirror housing 2 are an image capturing unit 3 and a side-turn lamp 4 as an visible-light emitting unit. The side-turn lamp 4 emits yellow visible light. The relative positional relation between the image capturing unit 3 and the side-turn lamp 4 is such that the visible light emitted from the side-turn lamp 4 does not directly enter the image capturing unit 3.

In other words, as shown in FIG. 1 to FIG. 3, the image capturing unit 3 is mounted on the front side F of the body and on the side closer to the mirror base 1 (closer to the body) with respect to the side-turn lamp 4. On the other hand, the side-turn lamp 4 is mounted on the rear side B of the body and on the opposite side (outer side with respect to the body) to the side closer to the mirror base 1. The side-turn lamp 4 is provided along the longitudinal direction of the mirror housing 2 (direction from the mirror base 1 to the opposite side to the mirror base 1).

Provided on the back of the mirror housing 2 are an image capturing window 31 of the image capturing unit 3 and a lens 41 of the side-turn lamp 4. The image capturing window 31 is provided slightly downward. On the other hand, the lens 41 is provided in the substantially horizontal direction and is directed toward the front side F of the body. The lens 41 is made of a material having optical transparency that transmits visible light emitted from the side-turn lamp 4, and the side-turn lamp 4 is covered with the lens 41.

The image capturing unit 3 is, for example, a charge-coupled device (CCD) camera including a body 32 and an objective lens 33. The objective lens 33 faces the image capturing window 31. The image capturing unit 3 captures information within an image capturing range C in the front side F and the lower part of the body through the image capturing window 31. The image capturing range C includes the axle of the shaft of the left front wheel or around the ground plane thereof if the door mirror is mounted on the left side of the vehicle, and/or includes the axle of the shaft of the right front wheel or around the ground plane thereof if the door mirror is mounted on the right side of the vehicle.

The information captured by the image capturing unit 3 is displayed as image information on a display unit (e.g., a liquid crystal display) disposed near a driver's seat of the vehicle. Therefore, the problem of blind spots at the front wheel or around the ground plane thereof can be solved. The image capturing unit 3 may be mounted on the body so that it tilts to various angles with respect to the mirror housing 2. In this case, the image capturing unit 3 can be manually or remotely tilted, and therefore, the direction and the angle of capturing the image capturing range C can be controlled.

The side-turn lamp 4 includes at least one LED and a light source 5 such as an incandescent lamp. The light source 5 of the side-turn lamp 4 faces the lens 41 of the mirror housing 2. The side-turn lamp 4 has a visible-light distribution controller (not shown) that controls the distribution of light, that is, illuminates a light illumination range L in the front side F of the body with light (yellow visible light) from the light source 5 through the lens 41. Furthermore, the side-turn lamp 4 includes the light source 5, a holder for holding the light source 5, and the visible-light distribution controller, which are formed as a unit construction.

The side-turn lamp 4 illuminates the light illumination range L with light from the light source 5 through the lens 41 to perform a turn signal function. Using the side-turn lamp 4 allows lamps as follows to be omitted. The lamps include side-turn lamps (side turn signal lamps) or side marker lamps mounted on both sides of the fender of the vehicle, and/or turn lamps of front combination lamps mounted on both sides of the front of the vehicle.

The image capturing unit 3 captures information in the image capturing range C to display the information on the display unit, and it is thereby possible to solve the blind spot at the axle shaft of the front wheel or around the ground plane thereof. On the other hand, the side-turn lamp 4 blinkingly illuminates the light illumination range L, and it is thereby possible to perform the turn signal function.

In the above case, the relative positional relation between the image capturing unit 3 and the side-turn lamp 4 mounted on the mirror housing 2 is provided in such a manner that the light emitted from the side-turn lamp 4 does not directly enter the image capturing unit 3. In other words, the image capturing unit 3 is mounted on the front side F of the body with respect to the side-turn lamp 4, while the side-turn lamp 4 is mounted on the rear side B of the body with respect to the image capturing unit 3. The objective lens 33 of the image capturing unit 3 faces the image capturing window 31 that is provided slightly downward. On the other hand, the light source 5 of the side-turn lamp 4 faces the lens 41 that is provided in the substantially horizontal direction and is directed toward the front side F of the body.

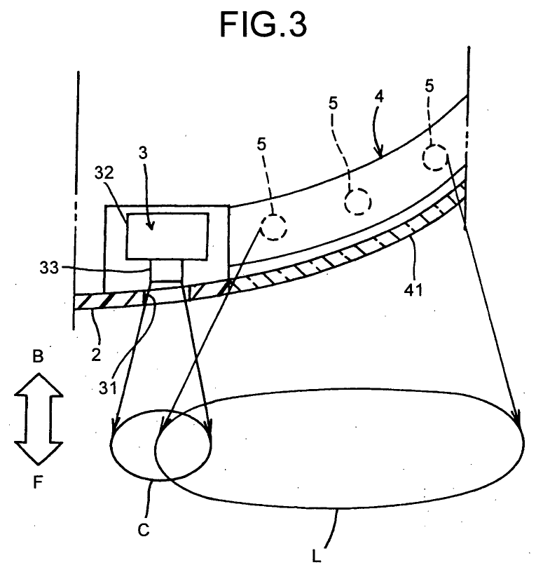

Consequently, the light emitted from the light source 5 is prevented from directly entering the objective lens 33. It is noted that even if the image capturing range C of the image capturing unit 3 and the light illumination range L of the side-turn lamp 4 are partially or entirely superposed on each other as shown in FIG. 3, the light emitted from the side-turn lamp 4 does not directly enter the image capturing unit 3.

Therefore, the outside mirror 100 according to the first embodiment has such a feature that blooming does not occur in a video image captured by the image capturing unit 3, and it is therefore possible to obtain clear visibility. Further, it is prevented to reduce performance such as minimum subject illumination by the additional components such as a filter and to increase component costs.

Furthermore, by providing the side-turn lamp 4 in the outside mirror 100 according to the first embodiment, the side-turn lamp, the side marker lamp, and the turn lamp of the front combination lamp can be omitted therefrom. Consequently, it is possible to prevent the light emitted from the lamp mounted on the vehicle from directly entering the image capturing unit 3.

The outside mirror 100 has the visible-light distribution controller in the side-turn lamp 4, and therefore, the distribution of the visible light from the light source 5 within a predetermined light illumination range L is controlled by a visible-light distribution controller. Furthermore, the outside mirror 100 has the side-turn lamp 4 that is formed as a unit construction, and therefore, the side-turn lamp 4 is shared by outside mirrors for various types of vehicles. In addition, in the outside mirror 100, the side-turn lamp 4 is covered with the lens 41, which makes it possible to protect the side-turn lamp 4 against cloud of dust or the like.

In the outside mirror 100, the image capturing unit 3 is manually or remotely tilted to adjust the image capturing range C. If the image capturing range C is adjusted, light emitted from the light source 5 of the side-turn lamp 4 requires control so as to prevent the light from directly entering the objective lens 33.

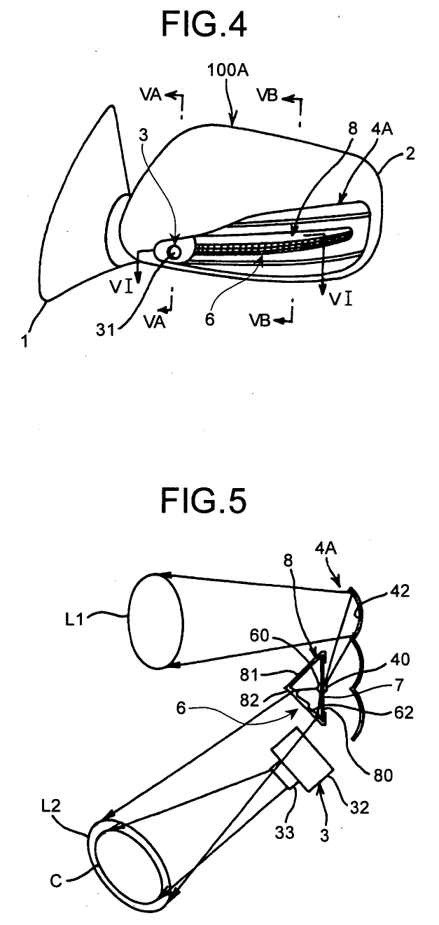

FIG. 4 to FIG. 9 are schematic diagrams of an outside mirror for a vehicle, according to a second embodiment of the present invention. An outside mirror 100A according to the second embodiment has the substantially same configuration as that of the outside mirror 100 according to the first embodiment. That is, as shown in FIG. 4, the outside mirror 100A is a door mirror mounted on the left side of the vehicle, and includes the mirror base 1 and the mirror housing 2. The back of the mirror housing 2 is directed toward the front side F of the body.

Mounted on the lower part of the back of the mirror housing 2 are an image capturing unit 3 the same as that according to the first embodiment, a side-turn lamp 4A as the visible-light emitting unit, and an infrared emitting unit 6. The image capturing unit 3 may be mounted so as to tilt in various angles with respect to the mirror housing 2. In this case, the image capturing unit 3 is manually or remotely tilted to control the direction and angle of capturing the image capturing range C. The side-turn lamp 4A and the infrared emitting unit 6 form a lighting system. The side-turn lamp 4A emits yellow visible light. The relative positional relation between the image capturing unit 3 and the side-turn lamp 4A of the lighting system is provided in such a manner that visible light emitted from the side-turn lamp 4A is prevented from entering the image capturing unit 3.

As shown in FIG. 4 to FIG. 6, the image capturing unit 3 is mounted on the front side F of the body and the side closer to the mirror base 1 (closer to the body) with respect to the side-turn lamp 4A of the lighting system. On the other hand, the side-turn lamp 4A is mounted on the rear side B of the body and the opposite side (outer side with respect to the body) to the side closer to the mirror base 1 with respect to the image capturing unit 3. Further, the side-turn lamp 4A and the infrared emitting unit 6 are provided along the longitudinal direction (the direction from the mirror base 1 to the opposite side thereto) of the mirror housing 2.

The infrared emitting unit 6 includes LEDs 60 that emit infrared rays as a light source. On the other hand, the side-turn lamp 4A includes LEDs 40 that emit visible light as a light source. The LEDs 40 are LEDs in a range of yellow or amber color with a wavelength characteristic of around 590 nanometers defined by regulations of the side-turn lamp. The LEDs 60 are LEDs that emit infrared rays with characteristics of a wavelength of around 950 nanometers.

The LEDs 60 are mounted over one surface of the substrate 7, and the LEDs 40 are mounted over the other surface of the substrate 7. In other words, the LEDs 40 and the LEDs 60 share the same substrate 7. The substrate 7 is a flexible substrate. The surface mounting of the LEDs 40 and LEDs 60 is realized by bonding chips of the LEDs on both surfaces of the flexible substrate 7, and covering the chips with lenses which are fixed to the surfaces of the flexible substrate 7. The flexible substrate 7 is held by a holder 8.

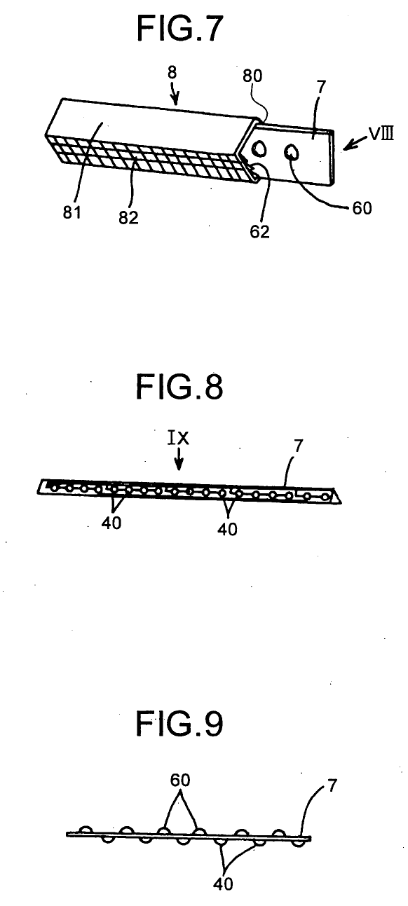

As shown in FIG. 5 and FIG. 7, the holder 8 is formed of synthetic resin or glass and has an angular shape formed with an upper surface 81 and a lower surface 82 with a side face 80 that are open. The edges of the opening on the side face of the holder 8 hold the flexible substrate 7. The flexible substrate 7 is mounted so that the LEDs 60 are directed toward inside of the holder 8. The holder 8 is disposed so that the top of the angular shape formed with the upper surface 81 and the lower surface 82 is directed toward the front side F of the body.

The side-turn lamp 4 includes a visible-light distribution controller 42. The visible-light distribution controller 42 is a reflector in this example. The reflector 42 is mounted on the mirror housing 2 that is disposed on the rear side (rear side B of the body) farther than the LEDs 40, and faces the LEDs 40. The reflector 42 controls the distribution of light emitted from the LEDs 40 to reflect the light toward a visible-light distribution range L1 in the front side F of the body. The reflector 42 has a curved surface for direct control formed on the mirror housing 2, and has a reflecting surface formed by means of direct vapor deposition, plating, or highly reflective coating. However, the reflecting surface may be formed with a metal component to be disposed inside the side-turn lamp 4.

The side-turn lamp 4 makes visible light from the LEDs 40 reflected by the reflector 42 and controls the distribution of the visible light to illuminate the light illumination range L1 in the front side F of the body. As a result, the relative positional relation between the side-turn lamp 4 and the image capturing unit 3 is such that the light emitted from the side-turn lamp 4 does not directly enter the objective lens 33 of the image capturing unit 3. Further, the side-turn lamp 4 performs a turn signal function. Accordingly, side turn (marker) lamps mounted on both sides of the fender of the vehicle and turn lamps of front combination lamps mounted on the both sides of the front part of the vehicle can be omitted.

The infrared emitting unit 6 includes an infrared distribution controller 62. The infrared distribution controller 62 is a prism provided inside the lower surface 82 of the holder 8 in this example. The prism 62 controls the distribution of infrared rays emitted from the LEDs 60 so as to illuminate a range substantially the same as the image capturing range C (lower part of the front of the body) of the image capturing unit 3 or a range L2 wider than the image capturing range C. The upper surface 81 of the holder 8 may allow the infrared rays from the LEDs 60 to pass through as it is, or may cut it.

The infrared emitting unit 6 refracts the infrared rays from the LEDs 60 by the prism 62 and controls the distribution thereof to illuminate the range substantially the same as the image capturing range C or the range L2 wider than the image capturing range C. Even if the optical axis of the image capturing unit 3 is different from the optical axis of the LEDs 60, the infrared rays from the LEDs 60 can be distributed within the image capturing range C, i.e., the predetermined range L2.

The side-turn lamp 4 and the infrared emitting unit 6 constitute a lighting system, which is formed as a unit construction.

The outside mirror 100A according to the second embodiment is formed as explained above, and the effects thereof are explained below. The image capturing unit 3 is operated with a switch (not shown) in the vehicle to cause infrared rays to be emitted from the LEDs 60. In response to the emission, the infrared rays from the LEDs 60 pass through the prism 62 to be illuminated to the range substantially the same as the image capturing range C (lower part of the front of the body) or the range L2 wider than the image capturing range C. As a result, a video image of the lower part of the front side F of the body is displayed on an in-vehicle monitor or the like, which allows the blind spot at the axle of the front wheel of the vehicle or around the ground plane thereof to be solved. During daylight, the LEDs 60 may be controlled so as not to be emitted, through operation of the image capturing unit 3.

By blinkingly emitting the side-turn lamp 4 with a switch inside the vehicle, the visible light from the LEDs 40 is reflected by the reflector 42 to be illuminated blinkingly to the visible-light distribution range L1. The visible light from the LEDs 60 is amber color, and functions as the side-turn lamp 4.

As explained above, in the outside mirror 100A according to the second embodiment, the image capturing unit 3 captures the information in the image capturing range C and displays it on the display unit to solve the blind spot at the axle of the front wheel of the vehicle or around the ground plane thereof. On the other hand, the side-turn lamp 4A performs a turn signal function by blinkingly illuminating the light illumination range L1.

The relative positional relation in this case between the image capturing unit 3 and the side-turn lamp 4A mounted on the mirror housing 2 is such that the light emitted from the side-turn lamp 4A does not directly enter the image capturing unit 3. In other words, the image capturing unit 3 is mounted on the front side F of the body with respect to the side-turn lamp 4A while the side-turn lamp 4A is mounted on the rear side B of the body with respect to the image capturing unit 3. The objective lens 33 of the image capturing unit 3 is provided slightly downward, while the visible light emitted from the side-turn lamp 4A is directed toward the front side F of the body.

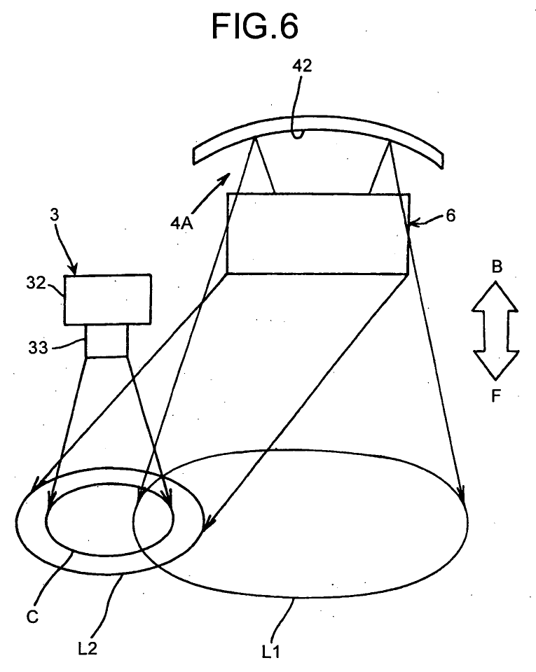

Consequently, the light emitted from the LEDs 40 of the side-turn lamp 4A is prevented from directly entering the objective lens 33 of the image capturing unit 3. As shown in FIG. 6, even if the image capturing range C of the image capturing unit 3 and the light illumination range L1 of the side-turn lamp 4A are partially or entirely superposed on each other, the light emitted from the side-turn lamp 4A is prevented from directly entering the image capturing unit 3.

Therefore, in the outside mirror 100A according to the second embodiment, blooming does not occur in a video image captured by the image capturing unit 3, which makes it possible to obtain a clear visibility. Furthermore, it is prevented to reduce performance such as minimum subject illumination by the additional components such as filter and to increase component costs. In addition, by providing the side-turn lamp 4A in the outside mirror 100A according to the second embodiment, the side-turn lamp, the side marker lamp, and the turn lamp of the front combination lamp can be omitted therefrom. Consequently, the outside mirror 100A according to the second embodiment prevents the light emitted from the lamp mounted on the vehicle from directly entering the image capturing unit 3.

The outside mirror 100A according to the second embodiment has the reflector 42 as the visible-light distribution controller in the side-turn lamp 4A. Therefore, the reflector 42 can control the distribution of the visible light emitted from the LEDs 40 within the predetermined light illumination range L1.

The outside mirror 100A according to the second embodiment includes the prism 62 as the infrared distribution controller in the infrared emitting unit 6. Therefore, the prism 42 can control the distribution of the infrared rays emitted from the LEDs 60 within the predetermined infrared distribution range L2. The infrared distribution range L2 is the range substantially the same as the image capturing range C of the image capturing unit 3 or wider than the image capturing range C. The prism 62 is not necessarily provided if there is a unit that illuminates the image capturing range C with infrared rays emitted from the LEDs 60.

The outside mirror 100A according to the second embodiment includes an infrared transmitting lens, i.e., the holder 8 through which infrared rays from the LEDs 60 pass. Therefore, the holder 8 is capable of protecting the LEDs 60 against cloud of dust or the like.

The outside mirror 100A according to the second embodiment has the lighting system including the side-turn lamp 4A and the infrared emitting unit 6, the lighting system being formed as a unit construction. Therefore, the lighting system can be shared with outside mirrors for various types of vehicles.

In the outside mirror 100A according to the second embodiment, the image capturing unit 3 can be manually or remotely tilted, and therefore, the image capturing range C can be adjusted. If the image capturing range C is adjusted, the visible light emitted from the LEDs 40 requires control so that it is prevented from directly entering the objective lens 33 of the image capturing unit 3.

In the outside mirror 100A according to the second embodiment, the light source of the infrared emitting unit 6 includes the LEDs 60, and the light source of the side-turn lamp 4A includes the LEDs 40. Therefore, the outside mirror 100A is downsized and reduces power consumption as compared with a system that uses an incandescent lamp or infrared lamp.

In the outside mirror 100A according to the second embodiment, the LEDs 40 and the LEDs 60 are mounted on both surfaces of the substrate 7, respectively. Therefore, it is possible to largely reduce a space for installation of the light sources.

In the outside mirror 100A according to the second embodiment, the substrate 7 with two light emitting units of the LEDs 40 and the LEDs 60, a harness, and the holder 8 can be shared. Therefore, it is possible to reduce the number of components accordingly, and also reduce costs.

In the outside mirror 100A according to the second embodiment, the LEDs 40 and the LEDs 60 are mounted on both surfaces of the substrate 7, respectively. Therefore, it is possible to largely reduce the height of the light sources for the visible-light emitting unit (LEDs 40) and infrared emitting unit (LEDs 60) as compared with a light emitting unit that mounts a lead wire of the LEDs on the substrate by dip soldering. Thus, it is possible to increase the degree of flexibility of layout for the outside mirror for vehicles.

In the outside mirror 100A according to the second embodiment, the substrate 7 with the LEDs 40 and LEDs 60 mounted thereon is a flexible substrate. Therefore, it is possible to provide layout of a light source that follows a designed curved surface of the mirror housing 2. Accordingly, the degree of design flexibility of layout for the light source is increased.

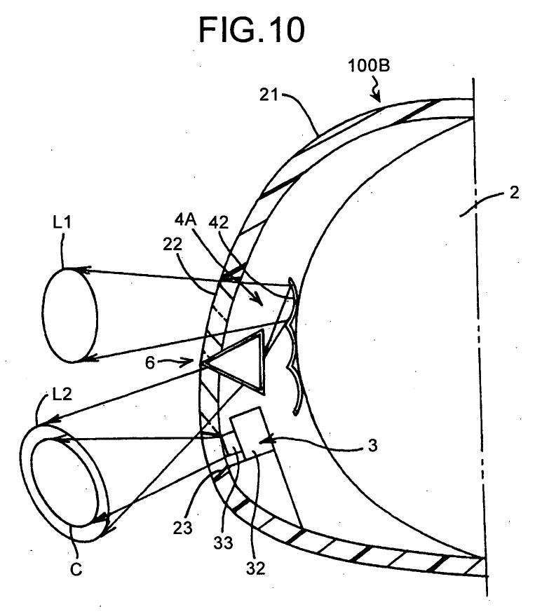

FIG. 10 is a cross section of an outside mirror according to a modification of the second embodiment. An outside mirror 100B has substantially the same configuration as the outside mirror 100 according to the first embodiment and the outside mirror 100A according to the second embodiment. As shown in FIG. 10, the image capturing unit 3, the side-turn lamp 4A, and the infrared emitting unit 6 are mounted in a designed cover (skull cap) 21.

In other words, the designed cover 21 covers the mirror housing 2, and the image capturing unit 3, side-turn lamp 4A, and the infrared emitting unit 6 are disposed between the mirror housing 2 and the designed cover 21. The designed cover 21 includes a lens 22 and an image capturing window 23. The lens 22 faces the reflector 42 of the side-turn lamp 4A, while the image capturing window 23 faces the objective lens 33 of the image capturing unit 3.

The outside mirror 100B according to the modification obtains substantially the same effects as that of the outside mirror 100 and the outside mirror 100A. Particularly, in the outside mirror 100B, as the side-turn lamp 4A is covered with the lens 22, it is possible to protect the side-turn lamp 4 against cloud of dust or the like.

It is noted that in the first and second embodiments, the image capturing unit 3 is positioned on the front side F of the body, while the side-turn lamp 4 or 4A is positioned on the rear side B of the body. Conversely, in the present invention, the image capturing unit 3 may be positioned on the rear side B of the body, while the side-turn lamp 4 or 4A may be positioned on the front side F of the body. In short, in the present invention, the relative positional relation between the image capturing unit 3 and the side-turn lamp 4 or the side-turn lamp 4A may be such that the light emitted from the side-turn lamp 4 or 4A is prevented from directly entering the objective lens 33 of the image capturing unit 3.

The side-turn lamps 4 and 4A as the visible-light emitting unit have been explained in the first and second embodiments. However, a lamp such as a pending lamp other than the side-turn lamp may be provided as the visible-light emitting unit. In the case of the pending lamp, an incandescent lamp may be used as a light source.

Furthermore, the door mirror has been explained in the first and second embodiments. However, another outside mirror for vehicles, for example, a fender mirror or a track mirror may be used in the present invention.

Moreover, in the second embodiment, the CCD camera as the image capturing unit 3 may be a special camera for infrared rays or a dual-purpose visible light and infrared camera.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An outside mirror for a vehicle, comprising:
an image capturing unit; and
a visible-light emitting unit that emits visible light, wherein
the visible-light emitting unit is arranged such that the visible light emitted does not directly enter into the image capturing unit.

2. The outside mirror according to claim 1, wherein the visible-light emitting unit functions as any one of a side-turn lamp, a side marker lamp, and a turn lamp of a front combination lamp of the vehicle.

3. The outside mirror according to claim 1, wherein the visible-light emitting unit includes a visible-light distribution controller that controls distribution of the visible light emitted within a predetermined range.

4. The outside mirror according to claim 1, further comprising
a lens that transmits the visible light emitted.

5. The outside mirror according to claim 1, wherein the visible-light emitting unit is provided as a unit part.

6. The outside mirror according to claim 1, wherein the image capturing unit has a mechanism to be tilted by manual operation or by remote operation.

7. The outside mirror according to claim 1, further comprising:
an infrared emitting unit that emits infrared ray.

8. The outside mirror according to claim 7, wherein the visible-light emitting unit functions as any one of a side-turn lamp, a side marker lamp, and a turn lamp of a front combination lamp of the vehicle.

9. The outside mirror according to claim 7, wherein the visible-light emitting unit includes a visible-light distribution controller that controls distribution of the visible light emitted within a predetermined range.

10. The outside mirror according to claim 7, wherein
the infrared emitting unit includes an infrared ray distribution controller that controls distribution of the infrared ray emitted within a predetermined range; and
the visible-light emitting unit includes a visible-light distribution controller that controls distribution of the visible light emitted within a predetermined range.

11. The outside mirror according to claim 7, further comprising
a first lens that transmits the visible light emitted.

12. The outside mirror according to claim 7, further comprising
a second lens that transmits the infrared ray emitted.

13. The outside mirror according to claim 7, wherein the infrared emitting unit is provided as a unit part.

14. The outside mirror according to claim 7, wherein
the infrared emitting unit includes an infrared source,
the infrared source includes at least one infrared light-emitting-diode that emits the infrared ray,
the visible-light emitting unit includes a visible-light source, and
the visible-light source includes at least one visible light-emitting-diode that emits the visible light.

15. The outside mirror according to claim 14, wherein
the infrared light-emitting-diode is mounted on one surface of a substrate, and
the visible light-emitting-diode is mounted on other surface of the substrate.

16. The outside mirror according to claim 15, wherein both the infrared light-emitting-diode and the visible light-emitting-diode are surface-mounted.

17. The outside mirror according to claim 15, wherein
the substrate is a flexible substrate.

18. The outside mirror according to claim 7, wherein the image capturing unit has a mechanism to be tilted by manual operation or by remote operation.

19. An outside mirror for a vehicle, comprising:
an image capturing unit; and
a visible-light emitting unit that emits visible light, wherein
the image capturing unit captures an image of an area illuminated by the visible-light emitted or near the area, and
the visible-light emitting unit is arranged such that the visible light emitted does not directly enter into the image capturing unit.

20. An outside mirror for a vehicle, comprising:
an image capturing unit; and
a visible-light emitting unit that emits visible light, wherein
the visible-light emitting unit illuminates an area where the image capturing unit captures an image or near the area, and
the visible-light emitting unit is arranged such that the visible light emitted does not directly enter into the image capturing unit.
